(19) United States
(12) Patent Application Publication
(10) Pub. No.: US 2025/0168026 A1
(43) Pub. Date: May 22, 2025

(54) PERCEIVED EYE-CONTACT IN LIVE VIDEO CONFERENCING SYSTEMS

(71) Applicant: Charter Communications Operating, LLC, St. Louis, MO (US)

(72) Inventor: Ian Biggs, Parker, CO (US)

(21) Appl. No.: 18/513,625

(22) Filed: Nov. 19, 2023

(51) Int. Cl. H04L 12/18; G06F 3/01; H04N 23/695; H04N 23/86

(52) U.S. Cl. CPC H04L 12/1831; G06F 3/013; H04N 23/695; H04N 23/86

(57) ABSTRACT

During a videoconference, with a first camera, capture an image of a first participant reflected from a first viewing screen collocated with the first participant and the first camera, while the first viewing screen is intermittently blacked out. Provide a sequence of the captured images over a network to at least a second viewing screen of a second participant.

### FIELD OF THE INVENTION

The present invention relates generally to the electrical, electronic and computer arts, and, more particularly, to video conferencing and the like.

### BACKGROUND OF THE INVENTION

There has recently been a significant increase in the use of video conferencing. In particular, internet-based video conferencing using personal computers, smart phones, and the like is very common in the current work environment.

One issue with video conferencing is that there is typically a disconnect between what the user is actually looking at and what the camera sees the user looking at. For example, with a desktop machine and separate camera and screen, a user may be looking at the other party's face on the screen, but the camera may be located one foot/0.3 m to the left of the screen, and therefore the camera “sees” the user looking to the right. With a laptop, the camera is typically located on the very top bezel, so the camera “sees” the user looking down. The perceived disconnect between the person to whom the user is speaking and the location where the user's eyes appear to be trained causes a lack of eye contact and detracts from the video conferencing experience.

### SUMMARY OF THE INVENTION

Principles of the invention provide techniques for improving perceived eye-contact in live video conferencing systems. In one aspect, an exemplary method includes operations of, during a videoconference, with a first camera, capturing an image of a first participant reflected from a first viewing screen collocated with the first participant and the first camera, while the first viewing screen is intermittently blacked out; and providing a sequence of the captured images over a network to at least a second viewing screen of a second participant.

In another aspect, a non-transitory computer readable medium includes computer executable instructions which when executed by a computer cause the computer to perform a method including: during a videoconference, causing a first camera to capture an image of a first participant reflected from a first viewing screen collocated with the first participant and the first camera, while the first viewing screen is intermittently blacked out; and providing a sequence of the captured images over a network to at least a second viewing screen of a second participant.

In still another aspect, an exemplary system includes a memory; and at least one processor, coupled to the memory, and operative to, during a videoconference, cause a first camera to capture an image of a first participant reflected from a first viewing screen collocated with the first participant and the first camera, while the first viewing screen is intermittently blacked out, and to provide a sequence of the captured images over a network to at least a second viewing screen of a second participant.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus (e.g., desktop computer with a camera and software/firmware components described herein) including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include, for example, software/firmware module(s) stored in a tangible computer-readable recordable storage medium (or multiple such media) and implemented on a hardware processor and/or other hardware elements, implementing the specific techniques set forth herein.

Aspects of the present invention can provide substantial beneficial technical effects. For example, one or more embodiments of the invention improve the technological process of videoconferencing by providing a perception of eye contact that more closely matches an in-person interaction as compared to current solutions, while requiring less processing power than potential solutions that use generative AI by modifying the video stream to overlay a correct gaze.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 shows a user interacting with a video conference system in accordance with an aspect of the invention;

FIG. 2 shows the system of FIG. 1 with the camera pointed in a different direction;

FIG. 3 shows a system similar to that of FIGS. 1 and 2 but using two cameras;

FIG. 4 shows the user on a video call with a single other person using the video conference system of FIG. 1, in accordance with an aspect of the invention;

FIG. 5 shows the user on a video call with multiple other people using the video conference system of FIG. 1, in accordance with an aspect of the invention;

FIG. 6 shows a timing diagram of video display output and camera inputs, in accordance with an aspect of the invention;

FIG. 7 is a block diagram of a video conference system in accordance with an aspect of the invention;

FIG. 8 is a block diagram of a computer system useful in connection with one or more aspects of the invention;

FIG. 9 is a block diagram of a “smart” cellular telephone useful in connection with one or more aspects of the invention; and

FIG. 10 is a block diagram of training a machine learning system to carry out inferencing for color correction and the like, in accordance with an aspect of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Visual conference software uses common computer monitors and cameras, or mobile devices which incorporate both in close proximity. However, the general effect is for most participants to be looking at their screens but to appear to be looking some degree of off-screen. Alternatively, if the user does look at the camera, this will provide the observer (remote video conference participant) with a forward view (commonly referred to as eye-contact in social settings). However, this will be at the cost of the speaker not directly looking at the speaker's screen so that the speaker may miss a visual cue, such as a listener making a confused expression to indicate that the listener does not understand.

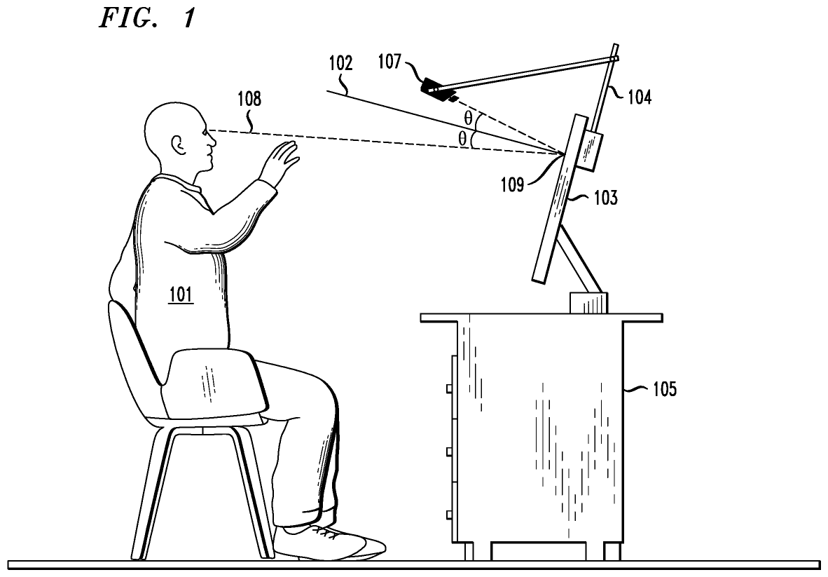

Advantageously, referring to FIG. 1, one or more embodiments reflect the camera's view off the screen towards the speaker. In one or more embodiments, the image is corrected in geometry and color. A beneficial effect is that viewers experience a more natural degree of ‘eye-contact.’In FIG. 1, note the user 101 observing computer screen 103 on desk 105 along line of sight 108. Also note the camera 107 which is directed at viewpoint 109 on screen 103 which reflects towards the eyes of the user 101. Note the normal 102 to the screen 103 emanating from viewpoint 109, with the angle of incidence equal to the angle of reflection (in each case, θ). Camera 107 is mounted on a gimbal 104 to allow it to point back at viewpoint 109 on screen 103. Note that the figures are not necessarily to scale and the size of certain features may be exaggerated to permit clear portrayal of angles and the like.

In one or more embodiments, the viewing system (e.g., screen 103) has a smooth, reflective surface that minimizes the loss of image quality being reflected. One or more embodiments cycle the image displayed on the screen to insert a momentary black image. In one or more embodiments, the rate at which this is done is directly proportionate to the frame-rate of the camera 107.

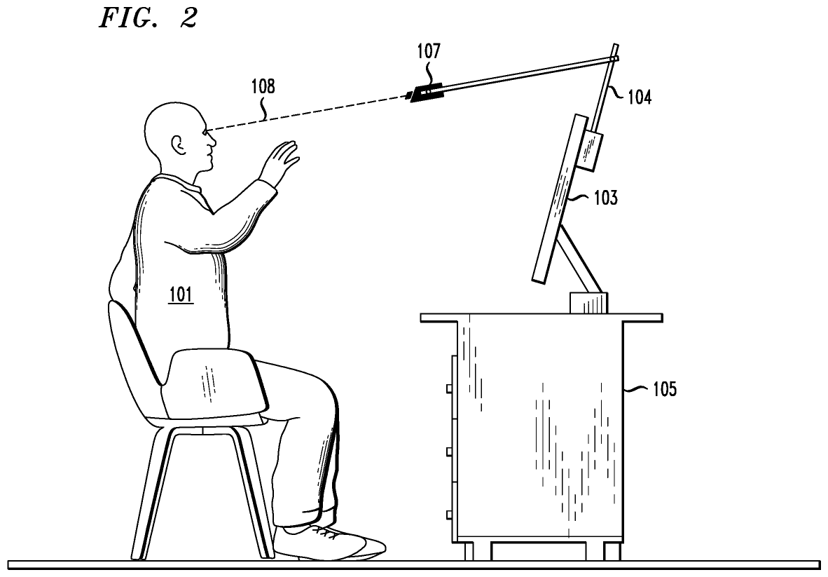

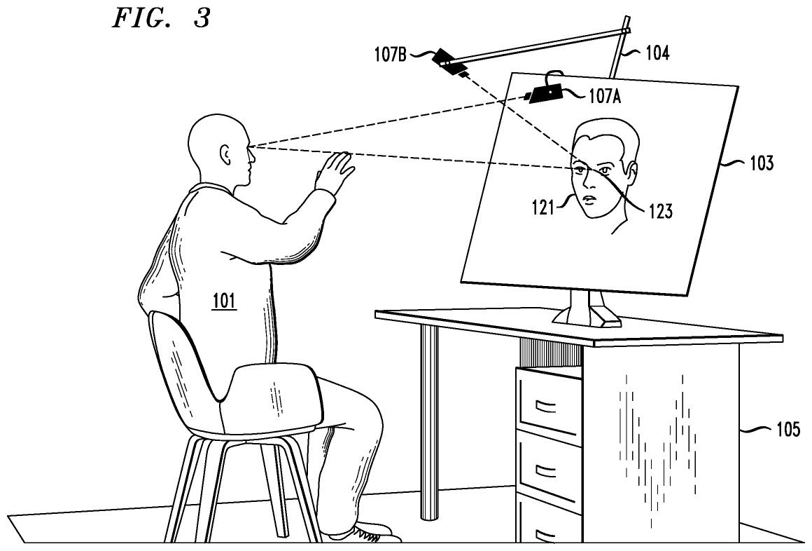

In one or more embodiments, the camera 107 moves between two positions; alternatively, two separate cameras are used. In the first position (or the first camera in the two-camera case), the camera takes a series of images in the typical configuration (i.e., physically offset some distance and angle from the screen 103 and pointed at the user 101) for purposes of establishing true colors for machine training purposes (discussed further below). FIG. 2 below shows the first position. FIG. 3 below shows the two-camera case.

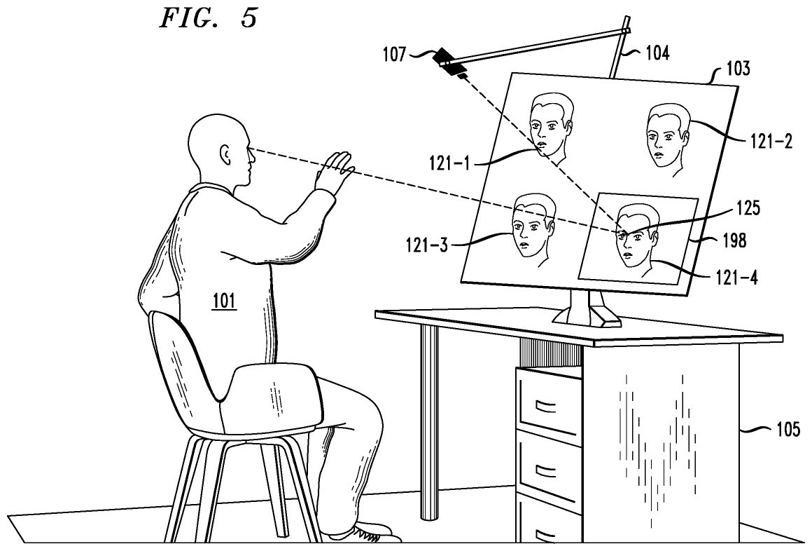

In the second position (or the second camera in the two-camera case), the camera is positioned as shown in FIG. 1 with the intended image reflected off the viewing screen towards the speaker. The camera 107 targets a position 109 on the viewing screen 103 (in one or more embodiments, the default is simply the geometric center of the screen). Alternatively, this point can be corrected based on where the viewer is actually looking on the screen. Several correction techniques are possible. Known eye-tracking techniques can be employed, but are error prone. Referring to FIG. 5 below, some embodiments take advantage of the fact that most remote visual conferencing software knows who is talking and who is muted at a given time, as well as the geometry of the displayed participants at any given time. Suppose, for example, that five people are on a call. “Mike” 101 is watching his screen, which depicts the other four participants 121-1, 121-2, 121-3, and 121-4 in a 2×2 grid. The lower right box on Mike's screen shows “Alice” 121-4, who is currently presenting. While it is easy to further determine the location of Alice's face in the highlight box 198, it is not necessary in one or more embodiments inasmuch as one would expect to find it centered and ⅔ of the way up vertically. Taking that as the point of reflection provides an acceptable approximation of Alice's eyes.

The display 103 inserts a black frame at a predictable interval, optionally signaling to the camera 107 that the display 103 is in a ready-state to take an image. The camera 107 takes an image, reflected off the display screen 103 of the speaker 101. After the camera takes the image, the screen is restored to the normal video conference view, and the image taken by the camera is corrected for the ‘key-stone’ effect (i.e., because of the potentially short distance from the camera 107 to the reflecting surface of the display device 103, the captured images will appear compressed at the top section of the image and artificially stretched at the bottom).

The image's colors are then corrected; for example, through a predictive deep-learning model which has optionally been trained with the image collected in the first position (or by the first camera in the two-camera case), as discussed above. The captured and corrected image is sent through software; given the teachings herein, the skilled person can adapt known techniques used in common computer-connected cameras.

FIG. 10 shows exemplary training and deployment of a machine learning model 201. The model is initially fit on a training data set 203, which is used to fit the weights of the connections between the neurons in artificial neural networks; during this phase of training, the prediction 211 is compared with a target and the model adjusted as needed. Validation data set 205 is used to tune the hyperparameters such as the number of hidden units in each layer. For example, training in this phase can be stopped when the prediction produces increasing rather than decreasing error. Test data 207 is a set of examples used to assess the performance (i.e. generalization) of a fully specified classifier (predictions 211 at this stage are classifications of examples in the test set). Those predictions are compared to the true classifications and if acceptable, the model 201 is deployed and used for inferencing where the prediction 211 will be the corrected image or the like.

As noted, in one or more embodiments, the point of reflection 109 targeted off the viewing screen 103 is assumed to be the center of the physical screen. However, in some instances, the camera can adjust to the target (i.e., point on the screen 103 where the speaker is actually looking) by adjusting the position of the camera based on the user's eye position. In an optional approach, the target position could be taken as an average of the relative position of the speakers eyes, in a situation where there are multiple speakers at the same time. In some instances, viewers have a single camera, and it is desired to give the impression that each of the other participants are being looked at in the eyes simultaneously.

FIG. 1 thus provides a profile view of a user 101 in front of a computer monitor 103 with camera 107. Unlike the normal orientation of facing the user (i.e., the first position (or the first camera in the two-camera case))−the camera is tilted downwards and at the center of the screen recording the reflection of the user (i.e., the second position (or the second camera in the two-camera case)).

FIG. 2 shows the system of FIG. 1 with the camera 107 in the normal, first position, pointed at the user 101 along line-of-sight 108.

FIG. 3 shows a view of an alternative system with first and second cameras 107A and 107B, the first pointed at the user 101, and the second pointed at the screen 103. The user 101 is on a video conference call with one other person 121. Note that camera 107B is mounted on a gimbal 104 in the same manner as camera 107 in FIG. 1, to permit being pointed at the screen at an appropriate angle to the point 123 where the user's eyes are looking, and that camera 107A can be pointed at the user with or without the use of a gimbal.

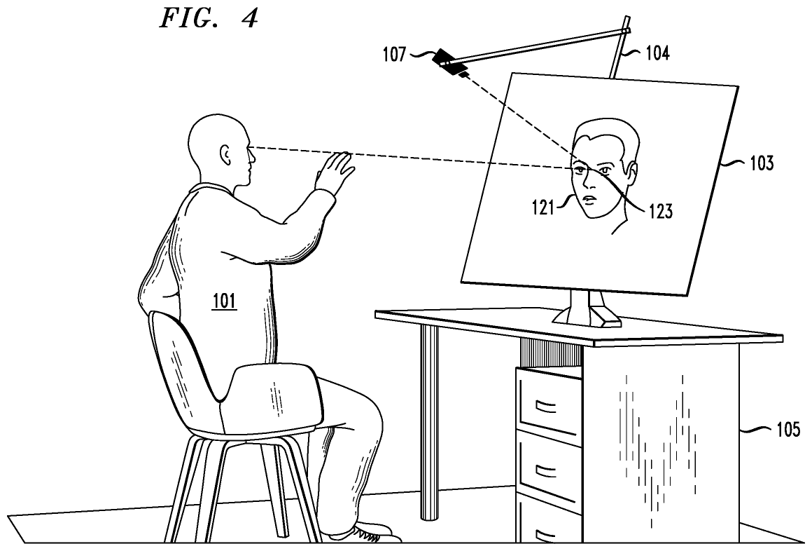

In FIG. 4, the user 101 is on a video conference call with one other person 121. The camera 107 has tracked the user's eyes and is capturing the outgoing video from the point 123 on the screen where the user's eyes are looking. Note that camera 107 is mounted on a gimbal 104 in the same manner as camera 107 in FIG. 1, to permit being pointed at the screen at an appropriate angle.

In FIG. 5, the user 101 is on a video conference call with multiple people 121-1, 121-2, 121-3, 121-4. The camera 107 has tracked the user's eyes and is capturing the outgoing video from the point 125 on the screen where the user's eyes are looking, or alternatively, the video conferencing software highlights the image of the speaker (e.g., outline 198) and the system determines this by interacting with the video conferencing software using an API or the like. Note that camera 107 is mounted on a gimbal 104 in the same manner as camera 107 in FIG. 1, to permit being pointed at the screen at an appropriate angle.

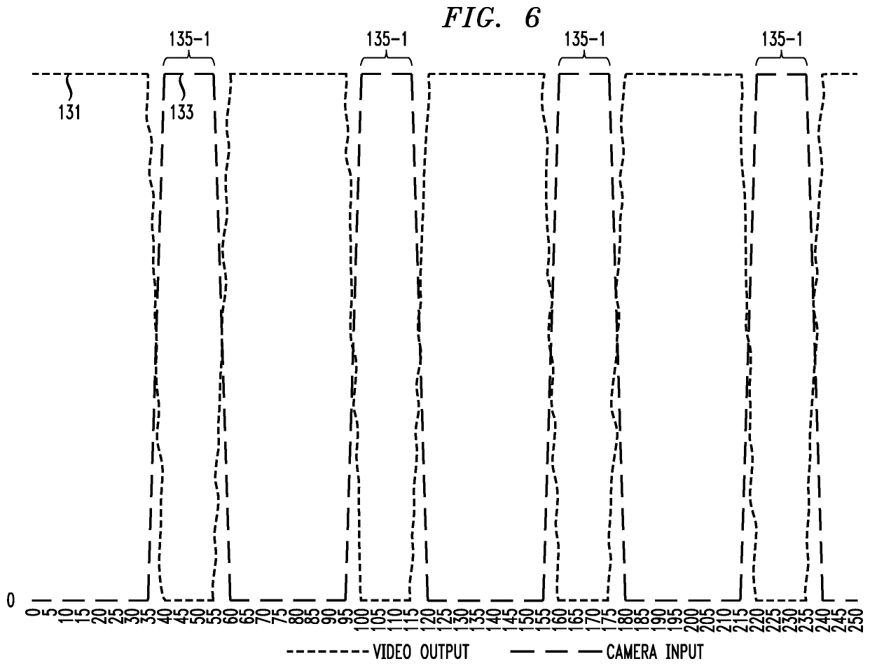

FIG. 6 shows a time series, with the horizontal access in milliseconds (0 to 250 milliseconds). In this example, the black frame insertion occurs four times per 250 ms (or sixteen times per second), at which time the display renders a ‘black image’ and the camera captures the user. In one or more embodiments, the captured incoming image will be color desaturated. However, it can be color corrected with a machine learning convolutional neural network (CNN) model or the like as depicted and discussed with respect to FIG. 10 (which can be included, for example, within functionality 585 of element 597). In FIG. 6, the video output is illustrated as short-dash dashed line 131 while the camera input is illustrated as long-dash dashed line 133. In essence, the default is condition 131 with the screen displaying video, but during the four blacked-out periods 135-1, 135-2, 135-3, and 135-4, the screen is blacked out and the camera captures a screen reflection as input.

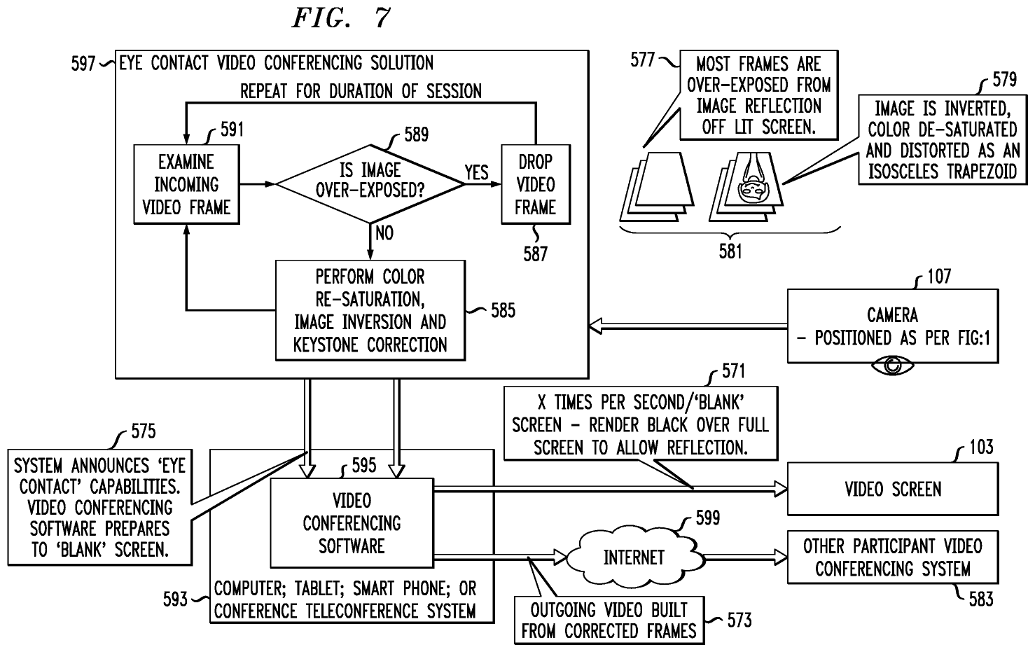

Referring to FIG. 7, note the camera 107 which has been positioned to capture an image off a screen 103 for purpose of web-conferencing. In normal operation (i.e., in FIG. 6 other than at 135-1, 135-2, 135-3, and 135-4), no suitable image is received from the camera, since the emissive light from the display is much greater than the reflected light of the room. As seen at 571, the video conferencing software 595 running on machine 593 (e.g., computer, tablet, “smart” phone, or dedicated teleconference system) periodically instructs the display 103 to ‘blank’ or display a full black image momentarily to allow a reflected image to be captured (i.e., in FIG. 6 at 135-1, 135-2, 135-3, and 135-4). Camera 107 is thus positioned to capture images which are reflected off video screen 103.

Referring to 579, in one or more embodiments, there are one or more additional step(s) to correct, for example, three issues with the image. The first issue is that the image is upside down (inverted); the second issue is that the colors of the images in the room will be de-saturated or washed-out; and the third is that, from being reflected so closely, the image will have a key-stone effect, appearing wider at the top than at the bottom. Note the images (frames) 581. As indicated at 577, most frames will typically be over-exposed from the image reflection off the screen. In this aspect, the camera captures all the frames and the frames taken when the screen is not blanked are discarded. A camera very close to a monitor/screen will be washed-out/over exposed/or sometimes described a ‘hot’ as there is not enough contrast in the light gathered to create a useable image; this aspect is referred to herein as being “overexposed.”

The eye contact video conferencing solution 597 can, for example, be implemented in software. Such software can execute, for example, on a modified web-camera 107, which, at 575, announces its eye contact capabilities to video conferencing software 595 which prepares to blank the screen. In an alternative, such software executes on a device which is in between the camera 107 (e.g., a common USB camera) and the computer hardware 593 running the video conferencing software 595. In another alternative, the video conferencing software 595 performs the same function; i.e., accepting the frames of video and applying corrective measures. In this latter aspect, the software implementing the eye contact video conferencing solution 597 runs on machine 593 and is part of the software 595 or else interfaces with the software 595 using a suitable interface, such as an application programming interface (API) or the like. In one or more embodiments, it is the responsibility of the video conferencing software to respond to the request to ‘blank’ the screen to capture an image. In some instances, when the camera is connected to the computer, it announces its capabilities to the video conferencing software.

By way of clarification and further comment, in some instances, the video conferencing software 595 accepts all the frames of video and applies the corrective measures; essentially, in a post-processing function. In some instances, the ‘out of the box’ video software is receiving mostly over-exposed images, but a software intermediary is removing the over-exposed frames and otherwise correcting (in the process effectively reducing the frame rate). Digital USB cameras are typically plugged in and a handshake occurs; the camera is not cycled on and off. In some cases, a standalone camera can be provided with a light sensor and include logic to determine that the image is overblown due to reflection. In another aspect, a tilt sensor is provided, which detects that the camera is pointing down and thereby infer that it is pointing at the screen and the image will be overexposed (except during the blanking). Video conferencing software typically knows what camera is being used and accepts the data from the camera. In some instances, the camera has logic so as to not send overexposed images. Alternatively, the camera sends all the images including the overexposed images but software discards the overexposed images and retains the good images that come periodically during blacking. In still another option, the camera cooperates with the video card driver to capture good images during blacking/blanking and the video conference software is not in the loop with regard to this aspect.

Still with reference to solution 597, in one or more embodiments, throughout a videoconferencing session, each incoming video frame is examined at 591, and in decision block 589, it is determined whether the image is overexposed. If YES, drop the video frame at 587 and then continue monitoring. If NO, perform color re-saturation, image inversion, and keystone correction at 585 and keep the frame, and proceed back to 591 for the next frame.

Video screen 103 preferably has a glass or high-gloss surface, since anti-glare coatings will tend to diffuse the image.

Video conferencing software 595 can run on machine 593 which can be, for example, a smartphone, a tablet, a laptop or desktop computer; a dedicated video conferencing system, or the like. Given the teachings herein, the skilled artisan can adapt known video conferencing software to interface with hardware and/or software implementing aspects of the invention, using APIs or the like.

At 573, the output of video conferencing software 595, which includes output video built from the corrected frames, is provided to the system(s) 583 of the other participant(s) over a network or network of networks such as the Internet 599.

In addition to the use of an “app,” a browser-based solution is also possible; it will be helpful if operating in full-screen mode.

One or more embodiments thus advantageously address the perceived lack of eye contact in video conferencing. While many monitor screens have anti-glare coating, which is undesirable in one or more embodiments, there are monitor screens available without anti-glare coating, and there are techniques to remove anti-glare coating when present. Furthermore, if using a screen with anti-glare coating, a glossy piece of acrylic or glass could be deliberately located over the surface of the monitor to enhance reflectivity. Furthermore, smart phones typically do not have an anti-glare coating, and when the screen is not active, it is typically highly reflective; essentially, a black mirror.

As noted, and as illustrated, for example, in FIG. 1, one or more embodiments position the camera 107 to bounce off the point of the screen 103 at which the user 101 is looking. The other party will then perceive that user 101 is looking at the other person's image. However, as noted, there is a potential problem in attempting to bounce off a thing (i.e., obtain a reflection from), a screen which is emitting light. One or more embodiments advantageously solve this technical problem through the blacking-out process.

Furthermore in this regard, referring again to FIG. 6, to address this problem, one or more embodiments make use of the fact that the video has a high frame rate, by blanking the screen for, say, 1/120^{th} of a second, 1/60^{th} of a second, 15 ms (as in the example of FIG. 6), 0.02 seconds, or other suitable interval, based on what the refresh rate of the monitor can support. The image is taken while the monitor is blanked/blacked, and those images are stitched together. The system ignores the parts where the screen is displaying image(s). In one or more embodiments, the camera just focuses on the middle of the screen. However, servos or the like can be used to tilt, shift, and/or crop the camera image to direct the camera closer to where the user 101 is looking. For example, FIGS. 1 and 2 respectively show the camera focused on the screen and on the user; the camera can optionally be moved with a servo or the like and this servo or the like could optionally be further used to direct the camera towards different locations on the screen 103 at which the user is looking (e.g., though eye tracking/gaze detection or the like, or by taking advantage of the fact that most remote visual conferencing software knows who is talking and who is muted at a given time, as well as the geometry of the displayed participants at any given time).

With continued reference to FIG. 6, a very high frame rate is not necessarily needed for teleconferencing. For example, in a teleconference of “talking heads” with limited motion, a frame rate of 10 frames per second may be adequate. It is worth noting that movie theaters typically use 24 frames per second, NTSC is 30 frames per second, PAL is 25 frames per second. Again, the line 131 is the video output, and the line 133 is the camera input; the time span where the camera is active is shown at 135-1, 135-2, 135-3, and 135-4.

In one or more embodiments, the camera and monitor are active the whole time; the camera and monitor are not being turned off and on. Rather, a black image is provided to the monitor so that it appears to be off and only the frames from the video stream that are obtained during the black periods are utilized. Perfect precision is not necessarily needed—the monitor is being “flickered” so fast that the human cannot perceive it. Images are captured during the flickers when the monitor is not off, but black, to “grab” the frames of video and stitch together the outbound video experience.

A non-limiting exemplary embodiment includes two components; namely, a timing component and a video artifacts component.

Timing component: In one or more embodiments, the timing is done in software. In some instances, the camera is aware that it should only be taking the frames when the video is “low” (i.e., blacked/blanked screen). The video conferencing software 595 (e.g., client software) is made aware of the timing requirements and inserts a black/blank frame every 1/120^{th} of a second, 1/60^{th} of a second, 15 ms (as in the example of FIG. 6), 0.02 seconds, or other suitable interval. The camera is advised to take a frame when the screen is blacked/blanked. As indicated at 573, the outgoing video is constructed from these frames stitched together. In an alternative approach, the camera captures frames continuously, and in decision block 589, frames that are overexposed from the light reflecting back from the monitor are discarded. Either approach can be used. In one or more non-limiting exemplary embodiments, the video conferencing software is used in full screen mode; it takes over the whole monitor so as to be able to turn off all the light being emitted from the monitor by blanking/blacking the display. Thus, the camera can be timed to only capture frames from reflection while the screen is blanked/blacked, or all frames can be captured and those captured when the screen is “live” can be discarded at 589, 587.

In one or more embodiments, the timing component is implemented within solution 597 and/or software 595. Software 595 can be a client on the person's machine 593 or can be implemented within a browser. In a non-limiting example, the vendor of the video conferencing software changes its client software to implement full screen mode and while in the full screen mode and implementing the eye contact solution, the video conferencing software “knows” that every 1/120^{th} of a second. 1/60^{th} of a second, 15 ms (as in the example of FIG. 6), 0.02 seconds, or other suitable interval, the video display should be blacked/blanked out to give the camera a chance to capture a reflected image.

Video artifacts component: Video artifacts are possible when capturing a reflected image off of a black shiny surface. As noted, one issue is that the colors are desaturated. Furthermore, referring back to FIGS. 1 and 4, because the camera 107 is at such an extreme angle there, there will be a keystoning effect because the top part of the image will be significantly wider than the bottom. In one or more embodiments, at 585, keystone correction is carried out and the colors are re-saturated. Given the teachings herein, the skilled artisan can adapt known techniques to re-saturate the colors. For example, there are known techniques to colorize a black and white photo, using machine learning; these can be adapted to re-saturate a badly de saturated color image. The de-saturation occurs because the image is reflected off the monitor which is not a perfect mirror. A certain amount of blurriness may also occur if there is an anti-glare coating on the screen, so one or more embodiments optionally employ a glossy screen without an anti-glare coating, or remove such a coating if present (or deliberately introduce a glossy piece of acrylic or glass as discussed above). Regarding the de-saturation, the colors are taken down a notch and are adjusted back in software on the fly in one or more embodiments, to avoid the undesirable appearance of being in a dark room.

One or more embodiments accordingly train and deploy machine learning image processing software. Optionally, a human expert could be employed to annotate a training set of desaturated images with the appropriate colors. To avoid the need for annotation by a human expert, the system can be trained off of a “good” image. That is to say, employ a good source image and the corresponding de-saturated image and train on that pair; i.e., train the system to produce the “good” image from the desaturated image.

It is worth noting that a default software mode and camera position can be provided for systems that do not have the hardware and/or software capability to implement the eye contact solution.

As noted above, in one or more embodiments, the camera has two modes as in FIGS. 1 and 2, or two cameras are used as in FIG. 3. If the user 101 joins a conference and is just watching other people, the special aspects provided by embodiments of the invention are not needed. One mode can be the camera just looking straight ahead like it normally does as in FIG. 2 (or camera 107A in FIG. 3) and the other one is an exemplary inventive mode as in FIG. 1 (or camera 107B in FIG. 3) where it is pointing down at the screen and bouncing off. So, when the camera is looking straight ahead, it can obtain a true image of colors and then it could look down and obtain the de-saturated view and adjustment can be carried out based on that. Thus, one or more embodiments do not necessarily need a large training corpus to obtain an acceptable color approximation. Business teleconferencing should require less stringent color correction than, say, a virtual tour of an art museum.

In another aspect, referring again to FIG. 5, consider that in common video conferencing software, the software notices when the person is talking, and highlights that person's image/avatar with a surrounding border 198 or the like—the software itself is aware of who is talking/presenting. With a camera capable of motion, an interface to the video conferencing software can make the system aware of which person should be the focus of the user's gaze at that point (i.e., user 101 should look at person 121-4 in FIG. 5).

In the example of FIG. 4, there is a one-to-one video conference conversation. The system bounces the image off the center of the monitor as seen at 123 and picks up only those frames of video when the screen is blacked/blanked (or captures all and discards the frames from when the screen is not blacked/blanked). A machine learning model is used to color correct the images before transmitting them to the person 121 on the other side. In the embodiment of FIG. 5, there are, say, four other people in the conference, 121-1, 121-2, 121-3, and 121-4, so there can potentially be four points of focus. Focus can be adjusted by actually physically tilting/panning the camera 107.

Referring again to the FIG. 7 block diagram, in one or more embodiments, solution 597 piggybacks on top of software 595; modifications are made to implement the eye contact enhancements, including blanking/blacking the screen 103 every 1/120^{th} of a second, 1/60^{th} of a second, 15 ms (as in the example of FIG. 6), 0.02 seconds, or other suitable interval. During those time periods, a message is pushed to software 595 to paint the screen 103 all black to give the camera 107 a chance to take a shot/frame. In one or more exemplary embodiments, the web cam 107 is “smarter” and carries out the color correction and/or key-stoning correction transparently to the video conferencing software. In this aspect, for example, software 595 just treats the camera feed normally and only needs to black/blank the screen so the camera can actually take a picture/frame of video.

Thus, in one or more embodiments, software 595 only has to do the blacking/blanking out; the software that controls the camera (e.g., solution 597) implements the keystone correction and also undertakes color correction with a machine learning model. Given the teachings herein, a variety of known keystone correction techniques (e.g., known mathematical/statistical relationships used in correcting short throw projectors) can be adapted by the skilled artisan to implement appropriate keystone correction. For example, there are mathematical techniques that can be applied in short throw projectors to deliberately distort an image before projection so that the image, when projected and subject to keystoning looks normal—these techniques can just as well be applied to un-distort the keystoned image. In some instances, the manner of correction will depend on whether the camera is fixed (relatively constant correction) or movable (dynamic correction). In one or more embodiments, the keystone correction is implemented in software. In some instances, the correction can be calibrated; for example, by using a suitable driver and giving the user controls on the software to increase/decrease correction until the image appears correct. For example, correct a case where the user's forehead appears too large and the user's chin appears too small. Some embodiments provide a manual slider or the like within the software, which applies keystone correction until the image appears in an appropriate manner. Accordingly, in one or more embodiments, logic/machine learning are provided within solution 597 for color re-saturation and keystone correction, and this feed is pushed down to the software 595 just like known video camera operation (e.g., USB). In this aspect, the camera and the solution 597 are just pushing images to software 595 and software 595 just sends the images over Internet 599 to other participant(s) 583.

The blocking/blanking aspect can be implemented in software 595, but other approaches are possible. For example, in some cases, solution 597 directly accesses the screen buffer to carry out the blocking/blanking. Generally, there are a number of ways to drop overexposed frames; such as “sending blackness” or holding the last non-overexposed image for longer. Suppose, for example, that a camera takes 60 frames per second, and it is desired to take a reflected view of the user by blocking/blanking 10 times per second. To fill a full second of video without choppiness, take a picture during 10 of the 60 frames per second and hold the image for twice as long. This aspect advantageously avoids choppiness/flashing in and out, by persisting the previous good quality frame, lowering the effective frame rate of the viewer. Motion interpolation can also be employed in some instances.

The required calculations including machine learning are within the capabilities of modern processors on personal computers, smart phones, and the like. Auxiliary or “dongle” cameras (e.g., Bluetooth) that can steer back towards the screen as in FIG. 1 will be appropriate for implementation on smart phones, laptops, tablets, etc. It is worth noting that in addition to being implemented on a desktop computer with a USB camera and commercial web-based video conferencing software, other embodiments could be employed with high-end telepresence systems using dedicated video conferencing rooms and the like.

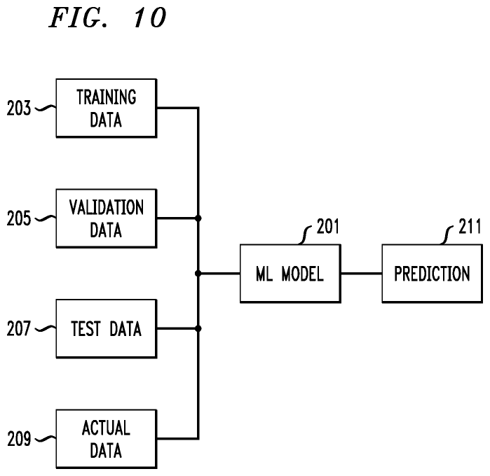

FIG. 9 shows an exemplary configuration of a mobile device 1021 such as a mobile phone, cellular-enabled tablet, or cellular-enabled laptop. Device 1021 includes a suitable processor; e.g., a microprocessor 1151. A cellular transceiver module 1161 coupled to processor 1151 includes an antenna and appropriate circuitry to send and receive cellular telephone signals, e.g., 3G, 4G, or 5G. A Wi-Fi transceiver module 1163 coupled to processor 1151 includes an antenna and appropriate circuitry to allow phone 1021 to connect to the Internet via a wireless network access point or hotspot.

In one or more embodiments, one or more applications in memory 1153, when loaded into RAM or other memory accessible to the processor cause the processor 1151 to implement aspects of the functionality described herein.

Touch screen 1165 coupled to processor 1151 is also generally indicative of a variety of I/O devices, all of which may or may not be present in one or more embodiments. Memory 1153 is coupled to processor 1151. Audio module 1167 coupled to processor 1151 includes, for example, an audio coder/decoder (codec), speaker, headphone jack, microphone, and so on. Power management system 1169 can include a battery charger, an interface to a battery, and so on. Bluetooth camera 1162 is mounted on a dongle or the like so that it can turn back towards the screen as in FIG. 1. A Bluetooth camera is a non-limiting example and other wireless or wired connections are possible.

It is worth mentioning that one or more embodiments can be employed in a variety of settings, such as work-related enterprise settings, for remote learning, and the like.

### Recapitulation

Given the discussion thus far, it will be appreciated that, in general terms, an exemplary method, according to an aspect of the invention, includes the steps of, during a videoconference, with a first camera 107, 107B, capturing an image of a first participant 101 reflected from a first viewing screen 103 collocated with the first participant and the first camera, while the first viewing screen is intermittently blacked out; and providing a sequence of the captured images over a network 599 to at least a second viewing screen of a second participant 583.

Some embodiments further include refraining from capturing images with the first camera while the first viewing screen is not temporarily blacked out (for example, the web camera driver has logic so that it does not send overexposed images).

On the other hand, some embodiments further include continuously capturing images with the first camera while the first viewing screen is not temporarily blacked out, and discarding those images captured with the first camera while the first viewing screen is not temporarily blacked out. Refer, for example, to FIG. 7, where solution 597 drops a vide frame at 587 if determined to be overexposed at 589.

One or more embodiments further include performing keystone correction on the sequence of the periodically captured images at 585.

One or more embodiments further include performing color re-saturation on the sequence of the periodically captured images at 585. Such performance of color re-saturation can include, for example, applying a machine learning model 201. One or more such embodiments further include training the machine learning model on pairs of properly saturated and desaturated images (e.g., using same as the training data 203 and validation data 205 and holding back some for use as test data 207).

One or more such embodiments further include gathering the desaturated images with the first camera and the properly saturated images with a second camera 107A directed at the first participant.

On the other hand, one or more such embodiments further include gathering the desaturated images with the first camera directed at the first viewing screen (FIG. 1) and gathering the properly saturated images with the first camera directed at the first participant (FIG. 2).

One or more embodiments further include performing image inversion on the sequence of the periodically captured images at 585.

One or more instances further include causing the first viewing screen to display in a full screen mode to prevent emission of extraneous light during the temporary black out (otherwise, other material besides the video conference could be displayed on part of the screen and prevent successful image capture).

One or more embodiments further include providing the first viewing screen without a non-reflective coating.

In one or more embodiments, the first camera is an external web camera, and a further step includes providing a desktop computer coupled to the external web camera, the first viewing screen, and the network.

One or more embodiments further include adjusting the first camera to point to a midpoint of the first viewing screen.

In a non-limiting example, servos or the like can be used to adjust the cameras aiming point.

One or more embodiments further include tracking gaze of the first participant; and adjusting the first camera to point to a location on the first viewing screen corresponding to the gaze of the first participant (e.g., as in FIG. 5, which can also be implemented based on an API hook into the software 595 to determine who is speaking, as discussed below).

As in FIG. 5, in one or more instances, providing the sequence of the periodically captured images over the network to at least the second viewing screen of the second participant further includes providing the sequence of the periodically captured images over the network to at least a third viewing screen of a third participant. Further steps include interfacing with video conferencing software 595 used for the video conference to determine which one of the first and second participants is speaking (e.g., 121-4); and adjusting the first camera to point to a location on the first viewing screen corresponding to the one of the first and second participants who is speaking.

In another aspect, a non-transitory computer readable medium includes computer executable instructions which when executed by a computer cause the computer to perform a method including any one, some, or all of the method steps described herein. For example, a non-transitory computer readable medium includes computer executable instructions which when executed by a computer cause the computer to perform a method including: during a videoconference, causing a first camera to capture an image of a first participant reflected from a first viewing screen collocated with the first participant and the first camera, while the first viewing screen is intermittently blacked out; and providing a sequence of the captured images over a network to at least a second viewing screen of a second participant.

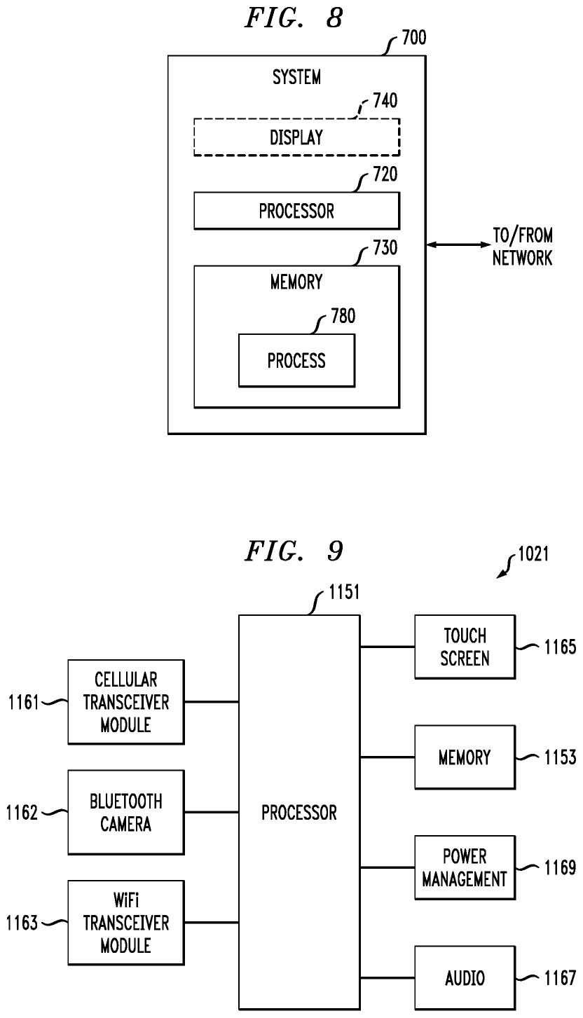

In another aspect, an exemplary system includes a memory (e.g., one or more of memory 730 in FIG. 8, memory 1153 in FIG. 9, memory of a camera 101, and the like); and at least one processor (e.g., one or more of processor 720 in FIG. 8, processor 1151 in FIG. 9, processor of a camera 101, and the like), coupled to the memory. The at least one processor coupled to the memory is operative to, during a videoconference, with a first camera (e.g., camera 107 or camera 107B), capture an image of a first participant 101 reflected from a first viewing screen 103 collocated with the first participant and the first camera, while the first viewing screen is intermittently blacked out. The at least one processor coupled to the memory is further operative to, during the videoconference, provide a sequence of the captured images 573 over a network (e.g., Internet 599) to at least a second viewing screen of a second participant 583.

In one or more embodiments, the at least one processor is further operative to refrain from capturing images with the first camera while the first viewing screen is not temporarily blacked out. For example, the display inserts a blank and tells the camera to be active only during the blanking, or alternatively the camera is default active but is instructed to not capture or to discard images except when the screen is blanked.

In one or more embodiments, the at least one processor is further operative to continuously capture images with the first camera while the first viewing screen is not temporarily blacked out, and to discard those images captured with the first camera while the first viewing screen is not temporarily blacked out. For example, solution 597 executing on the at least one processor discards overexposed (i.e., captured during non-blanking/non-blacking) images at 589, 587 but retains those that are not overexposed (i.e., captured during blanking/blacking) for further image correction and use. Such image correction can include, for example, keystone correction on the sequence of the periodically captured images (e.g., block 585 of solution 597); color re-saturation on the sequence of the periodically captured images (e.g., block 585 of solution 597); and/or image inversion on the sequence of the periodically captured images (e.g., block 585 of solution 597).

In none or more embodiments, performing color re-saturation includes applying a machine learning model 201 (which can be part of block 585, for example). The machine learning model can be trained, for example, on pairs of properly saturated and desaturated images, such as gathered by camera 107 in FIG. 2 directed at the first participant (saturated) and by camera 107 in FIG. 1 directed at the first viewing screen (not saturated), or such as gathered by the first camera 107A in FIG. 3 (properly saturated) and with the second camera 107B in FIG. 3 (not saturated).

As noted, keystone correction can be implemented, for example, in software (e.g., part of block 585) by adapting known mathematical correction techniques.

As will be appreciated by the skilled artisan, machine learning aspects can be implemented, for example, using software on a general purpose computer or on a high-speed processor such as a graphics processing unit (GPU), using a hardware accelerator, using hardware computation techniques, and the like.

Image inversion on the sequence of the periodically captured images can be implemented, for example, in software (e.g., part of block 585) by adapting known mathematical correction techniques.

In one or more embodiments, the at least one processor is further operative to cause the first viewing screen to display in a full screen mode to prevent emission of extraneous light during the temporary black out (for example, video conferencing software 595 enters full screen mode, possibly instructed by solution 597 or directly by user 101).

In one or more embodiments, the at least one processor is operative to provide the sequence of the periodically captured images over the network to at least a third viewing screen of a third participant, as in FIG. 5, and is further operative to: interface with video conferencing software used for the video conference to determine which one of the first and second participants is speaking (e.g., participant 121-4 in FIG. 5 as indicated by border 198); and adjusted the first camera to point to a location on the first viewing screen corresponding to the one of the first and second participants who is speaking (e.g., solution 597 hooks into software 595 vi an API to determine that it is participant 121-4 who is the current speaker and controls the camera 107 to point within border 198 approximately where the speaker's eyes are expected to be).

One or more embodiments of the system further include the first viewing screen 103 (generally represented by 740), typically coupled to the at least one processor, and which in one or more embodiments does not have a non-reflective coating.

In one or more embodiments of the system, the at least one processor includes at least a processor of a desktop computer, and the system further includes the first camera and the first viewing screen. The first camera is an external web camera and is coupled to the at least one processor, and the first viewing screen is coupled to the at least one processor. Further, the desktop computer includes a network interface coupled to the network. Sec, e.g., FIGS. 1 and 8 (double-headed arrow labeled to/from network).

One or more embodiments further include an adjustable mount, such as gimbal 104, configured to permit pointing the first camera (e.g., to allow it to point back at viewpoint 109 on screen 103, point at the user, etc. 104). The mount can be manually adjustable, or can use a servo or the like; for example, to point towards the place where the user 101 is gazing (which could be determined by image recognition coupled with deep learning, by optical tracking, or the like).

It is worth noting that subsequent references to the “at least one processor” are intended to refer to any one, some, or all of the processor(s) referred to in any previous recitation. Thus, if the at least one processor includes a processor associated with a camera and a main processor of a desktop computer, any action referred to as being taken by the at least one processor could be done by the processor associated with the camera, or the main processor of the desktop computer, or partly by each, whether in a first recitation or any subsequent recitation.

It is worth noting that the exemplary method can be implemented, for example, using the exemplary system as described. In some instances, a further step in the method can include instantiating any one, some, or all of the software components described herein, which then carry out method steps as described.

### System and Article of Manufacture Details

The invention can employ, for example, a combination of hardware and software aspects. Software includes but is not limited to firmware, resident software, microcode, etc. One or more embodiments of the invention or elements thereof can be implemented in the form of an article of manufacture including a machine readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus (e.g., desktop computer with a camera and software/firmware components described herein) including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include, for example, software/firmware module(s) stored in a tangible computer-readable recordable storage medium (or multiple such media) and implemented on a hardware processor and/or other hardware elements, implementing the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

FIG. 8 is a block diagram of at least a portion of an exemplary system 700 (e.g., desktop, laptop, tablet, smart phone) that can be configured to implement at least some aspects of the invention, and is representative, for example, of one or more of the apparatuses, desktop computers, laptop computers, tablets, smart phones, servers, or modules shown in the figures. As shown in FIG. 8, memory 730 configures the processor 720 to implement one or more methods, steps, and functions (collectively, shown as process 780 in FIG. 8). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC or FPGA rather than using firmware. Display 740 is representative of a variety of possible input/output devices (e.g., keyboards, mice, camera(s) 107, 107A, 107B, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising:
during a videoconference, with a first camera, capturing an image of a first participant reflected from a first viewing screen collocated with the first participant and the first camera, while the first viewing screen is intermittently blacked out; and
providing a sequence of the captured images over a network to at least a second viewing screen of a second participant.

2. The method of claim 1, further comprising refraining from capturing images with the first camera while the first viewing screen is not temporarily blacked out.

3. The method of claim 1, further comprising continuously capturing images with the first camera while the first viewing screen is not temporarily blacked out, and discarding those images captured with the first camera while the first viewing screen is not temporarily blacked out.

4. The method of claim 1, further comprising performing keystone correction on the sequence of the periodically captured images.

5. The method of claim 1, further comprising performing color re-saturation on the sequence of the periodically captured images.

6. The method of claim 5, wherein performing color re-saturation comprises applying a machine learning model.

7. The method of claim 6, further comprising training the machine learning model on pairs of properly saturated and desaturated images.

8. The method of claim 7, further comprising gathering the desaturated images with the first camera and the properly saturated images with a second camera directed at the first participant.

9. The method of claim 7, further comprising gathering the desaturated images with the first camera directed at the first viewing screen and gathering the properly saturated images with the first camera directed at the first participant.

10. The method of claim 1, further comprising performing image inversion on the sequence of the periodically captured images.

11. The method of claim 1, further comprising causing the first viewing screen to display in a full screen mode to prevent emission of extraneous light during the temporary black out.

12. The method of claim 1, further comprising providing the first viewing screen without a non-reflective coating.

13. The method of claim 1, wherein the first camera comprises an external web camera, further comprising providing a desktop computer coupled to the external web camera, the first viewing screen, and the network.

14. The method of claim 1, further comprising adjusting the first camera to point to a midpoint of the first viewing screen.

15. The method of claim 1, further comprising:
tracking gaze of the first participant; and
adjusting the first camera to point to a location on the first viewing screen corresponding to the gaze of the first participant.

16. The method of claim 1, wherein the providing of the sequence of the periodically captured images over the network to at least the second viewing screen of the second participant includes providing the sequence of the periodically captured images over the network to at least a third viewing screen of a third participant, further comprising:
interfacing with video conferencing software used for the video conference to determine which one of the first and second participants is speaking; and
adjusting the first camera to point to a location on the first viewing screen corresponding to the one of the first and second participants who is speaking.

17. A non-transitory computer readable medium comprising computer executable instructions which when executed by a computer cause the computer to perform a method comprising:
during a videoconference, causing a first camera to capture an image of a first participant reflected from a first viewing screen collocated with the first participant and the first camera, while the first viewing screen is intermittently blacked out; and
providing a sequence of the captured images over a network to at least a second viewing screen of a second participant.

18. A system comprising:
a memory; and
at least one processor, coupled to the memory, and operative to:
during a videoconference, cause a first camera to capture an image of a first participant reflected from a first viewing screen collocated with the first participant and the first camera, while the first viewing screen is intermittently blacked out; and
provide a sequence of the captured images over a network to at least a second viewing screen of a second participant.

19. The system of claim 18, wherein the at least one processor is further operative to cause the first camera to refrain from capturing images from while the first viewing screen is not temporarily blacked out.

20. The system of claim 18, wherein the at least one processor is further operative to cause the first camera to capture images while the first viewing screen is not temporarily blacked out, and to cause those images to be captured with the first camera while the first viewing screen is not temporarily blacked out.

21. The system of claim 18, wherein the at least one processor is further operative to perform keystone correction on the sequence of the periodically captured images.

22. The system of claim 18, wherein the at least one processor is further operative to perform color re-saturation on the sequence of the periodically captured images.

23. The system of claim 22, wherein the at least one processor is operative to perform color re-saturation by applying a machine learning model.

24. The system of claim 23, wherein the at least one processor is operative to train the machine learning model on pairs of properly saturated and desaturated images.

25. The system of claim 24, wherein the at least one processor is further operative to gather the desaturated images with the first camera and the properly saturated images with a second camera directed at the first participant.

26. The system of claim 24, wherein the at least one processor is further operative to gather the desaturated images with the first camera directed at the first viewing screen and to gather the properly saturated images with the first camera directed at the first participant.

27. The system of claim 18, wherein the at least one processor is operative to perform image inversion on the sequence of the periodically captured images.

28. The system of claim 18, wherein the at least one processor is operative to cause the first viewing screen to display in a full screen mode to prevent emission of extraneous light during the temporary black out.

29. The system of claim 18, further comprising the first viewing screen, coupled to the at least one processor, wherein the first viewing screen does not have a non-reflective coating.

30. The system of claim 18, wherein the at least one processor includes at least a processor of a desktop computer, further comprising:
the first camera, wherein the first camera is an external web camera and is coupled to the at least one processor; and
the first viewing screen, coupled to the at least one processor;
wherein the desktop computer includes a network interface coupled to the network.

31. The system of claim 30, further comprising an adjustable mount configured to permit pointing the first camera.

32. The system of claim 18, wherein the at least one processor is operative to provide the sequence of the periodically captured images over the network to at least a third viewing screen of a third participant, and wherein the at least one processor is further operative to:
interface with video conferencing software used for the video conference to determine which one of the first and second participants is speaking; and
adjust the first camera to point to a location on the first viewing screen corresponding to the one of the first and second participants who is speaking.
